(19) United States
(12) Patent Application Publication
(10) Pub. No.: US 2020/0370226 A1
(43) Pub. Date: Nov. 26, 2020

(54) LAUNDRY SYSTEM AND SYSTEM COMPONENTS USED IN SAME

(71) Applicant: Erika Marie Scheible, (US)

(72) Inventors: Erika Marie Scheible, Costa Mesa, CA (US); Geoffrey Lee Glidden, El Segundo, CA (US)

(73) Assignee: Erika Marie Scheible, Costa Mesa, CA (US)

(21) Appl. No.: 16/422,261

(22) Filed: May 24, 2019

(51) Int. Cl. D06F 39/00; D06F 39/10; D06F 39/08; D06F 58/24; D06F 29/00; C02F 9/00

(52) U.S. Cl. CPC D06F 39/006; D06F 39/10; D06F 39/085; C02F 1/001; D06F 58/24; D06F 29/005; C02F 9/00; D06F 39/088

(57) ABSTRACT

A laundry system is operable with only a standard power supply outlet. The laundry system can re-use water from an onboard tank component via integral plumbing components. The laundry system can comprise an onboard grey water treatment component to make system-assisted laundry more accessible to users with no designated facilities for this type of appliance. The laundry system can comprise filter cartridges that enables reuse of wash water for a plurality of wash cycles. A dryer of such a laundry system can be implemented in a manner that does not require a discharge vent and that harvests water from the dryer cycle for re-use within the wash cycles.

### FIELD OF THE DISCLOSURE

The disclosures made herein relate generally to laundry systems and, more particularly, a laundry system comprising a washer unit and dryer unit that can each reclaim wash water and that each require only a formal electrical service.

### BACKGROUND

It is well-known that traditional laundry systems typically include a washing machine that operate off of a formal water hook up and a dryer that needs to be connected to a vent, aside from both requiring formal electrical service. More specifically, current implementations of washing machines exhibit shortcomings such as, for example, being bulky and heavy, generating waste water for each wash cycle, causing wash water compositions to enter the water waste stream and requiring designated spaces with specific plumbing in dwellings. Similarly, current implementations of dryers exhibit shortcomings such as, for example, being bulky and heavy, wasting wash water, requiring designated spaces with specific venting in dwellings.

It is also well-known that water and energy conservation and waste stream management are considerations of global importance. As such, there is a global need for laundry systems and components thereof that provide for water and energy conservation as well as waste stream management. Moreover, there is a need for such laundry systems and components thereof in geographical locations (e.g., countries) where facilities often only offer standard electrical service (i.e., no water hook-up and/or discharge air vent).

Furthermore, a large number of apartment complex units, dorm rooms, recreational vehicles (RV's), cabins and the like do not have the formal facility hook ups for traditional washers and/or dryers beyond standard electrical service. Not to mention that traditional washers and dryers are often too large and bulky for effective and preferred use in many of these types of applications. Although there are alternatives to traditional washers and dryers for these types of applications (e.g., relatively small machines or machines having a washer and dryer integrated into a common enclosure), these alternative machines are generally too small, lack certain desired features, need one or more water containment structures thereof to be refilled with water a water supply for each load, require manual spinning for washing and/or drying, require a discharge air vent and other requirements not immediately provided for and/or not desirable.

Therefore, a laundry system and system components used therein that overcome shortcomings associated with conventional laundry system and system components thereof would be advantageous, desirable and useful.

### SUMMARY OF THE DISCLOSURE

Embodiments of the present invention are directed to a laundry system and system components used therein. More specifically, embodiments of the present invention provide a laundry system operable with only a standard power supply outlet (i.e., formal electrical service). The laundry system can re-use water from an onboard tank component via water reclamation plumbing and treatment components that are internally packaged in the system. To this end, the laundry system can comprise an onboard grey water treatment component to make system-assisted laundry more accessible to users with no designated facilities (e.g., plumbing, discharge vent or the like) for this type of appliance other than a standard power supply outlet. One or more filter cartridges, which preferably comprise non-toxic and degradable filter media and body, can be an integrated component of the laundry system. A dryer of such a laundry system preferably requires no discharge vent and harvests (i.e., reclaims) wash water from the dryer cycle for re-use within the wash cycle. Accordingly, system components of a laundry system configured in accordance with one or more embodiments of the present invention are advantageously implemented and integrated so as to overcome in a manner that overcome shortcomings associated with conventional laundry system and system components thereof.

In one or more embodiments of the present invention, a clothes washer comprises a first wash water container, a clothes-washing tub, a second wash water container, a filtration cartridge enclosure and a water filtration cartridge. The clothes-washing tub has a water inlet thereof in fluid communication with a water outlet of the first wash water container. The second wash water container has a water inlet thereof in fluid communication with a water outlet of the clothes-washing tub. At least a portion of an interior space of the clothes-washing tub is located at a position above the water inlet of the second wash water container thereby enabling wash water to be provided solely by gravity-fed flow from the clothes-washing tub to the second wash water container. The filtration cartridge enclosure has a water inlet thereof in fluid communication with a water outlet of the second wash water container through an interior space of the filtration cartridge enclosure and having a water outlet thereof in fluid communication with a water inlet of the first wash water container. The water filtration cartridge is removably mounted within an interior space of the filtration cartridge enclosure. The filtration cartridge enclosure and a body of the water filtration cartridge are jointly configured for causing an entire portion of wash water provided into an interior space of the filtration cartridge enclosure to pass through an interior space of the body of the water filtration cartridge before entering the water outlet of the filtration cartridge enclosure.

In one or more embodiments of the present invention, a laundry system comprises a wash water tank, a clothes-washing tub, a wash water sump, a water filtration structure, a water vapor condenser and an airflow structure. The clothes-washing tub is in fluid communication with the wash water tank to enable wash water to be provided from the wash water tank to the clothes-washing tub. At least a portion of an interior space of the wash water tank is located at a position above a water inlet of the clothes-washing tub for enabling wash water to be provided solely by gravity-fed flow from the wash water tank to the clothes-washing tub. The wash water sump in fluid communication with the clothes-washing tub to enable wash water to be provided from the clothes-washing tub to the wash water sump. At least a portion of an interior space of the clothes-washing tub is located at a position above a water inlet of the wash water sump thereby enabling wash water to be provided solely by gravity-fed flow from the clothes-washing tub to the wash water sump. The water filtration structure comprises a filtration cartridge enclosure and at least one water filtration cartridges. The filtration cartridge enclosure has a water inlet thereof in fluid communication with a water outlet of the wash water sump through an interior space of the filtration cartridge enclosure and has a water outlet thereof in fluid communication with a water inlet of the wash water tank. The at least one water filtration cartridge is removably mounted within an interior space of the filtration cartridge enclosure and provides water filtration functionality for enabling wash water to be re-used for a plurality of wash cycle instances. The water vapor condenser is in fluid communication with the wash water tank to enable condensed water vapor to be provided from the water vapor condenser to the wash water tank. The airflow structure comprises a clothes-drying tub, an air handler and the water vapor condenser. The clothes-drying tub, the air handler and the water vapor condenser jointly define an airflow pathway for enabling airflow therethrough in a circuitous manner from the clothes-drying tub to the air handler through the water vapor condenser and from the air handler to the clothes-drying tub.

In one or more embodiments of the present invention, a laundry system comprises a washer unit and a dryer unit. The washer unit comprises a clothes-washing tub, a wash water tank, a wash water sump, a water filtration structure, and a first water pump. A water outlet of the wash water tank is in fluid communication with a water inlet of the clothes-washing tub. A water outlet of the clothes-washing tub is in fluid communication with a water inlet of the wash water sump. A water inlet of the water filtration structure is in fluid communication with a water outlet of the wash water sump and a water outlet of the water filtration structure is in fluid communication with a water inlet of the wash water tank through the first water pump. At least a portion of an interior space of the wash water tank is located at a position above the water inlet of the clothes-washing tub for enabling wash water to be provided solely by gravity-fed flow from the wash water tank to the clothes-washing tub. The dryer unit comprises a clothes-drying tub, an air handler and a water vapor condenser. The clothes-drying tub, the air handler and the water vapor condenser jointly define an airflow pathway for enabling airflow therethrough in a circuitous manner from the clothes-drying tub to the air handler through the water vapor condenser and from the air handler to the clothes-drying tub. A condensed water vapor outlet of the water vapor condenser is located at a position above at least a portion of the interior space of the wash water tank thereby enabling condensed water vapor to be provided solely by gravity-fed flow from the water vapor condenser to the interior space of the wash water tank.

In one or more embodiments, the filtration cartridge can filter the wash water to permit the wash water to be reused for a plurality of wash cycle instances.

In one or more embodiments, the filtration cartridge can comprise one or more stages for particulate filtration, one or more stages providing flocculation and/or coagulation, and one or more stages for compound absorption.

In one or more embodiments, the filtration cartridge can comprise one or more media for providing removal of gross contaminants, one or more media for inducing flocculation, one or more media for removing dissolved solids, one or more media for inducing coagulation, one or more media for compound absorption.

In one or more embodiments, one or more water pumps can be provided for providing flow of condensed water vapor to the wash water tank.

In one or more embodiments, a wash water sanitizer can be provided for utilizing emitted light for sanitizing wash water.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a diagrammatic view showing a laundry system in accordance with one or more embodiments of the present invention.

FIG. 2 is a schematic view of the laundry system of FIG. 1, showing a wash water flow path of a washer unit of the system and an airflow path of a dryer unit of the system.

FIG. 3 is a diagrammatic view showing a water filtration cartridge configured in accordance with one or more embodiments of the present invention.

### DETAILED DESCRIPTION

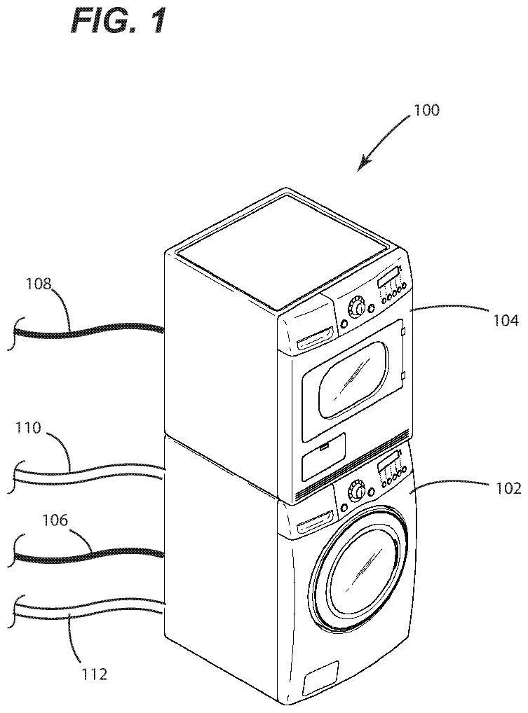

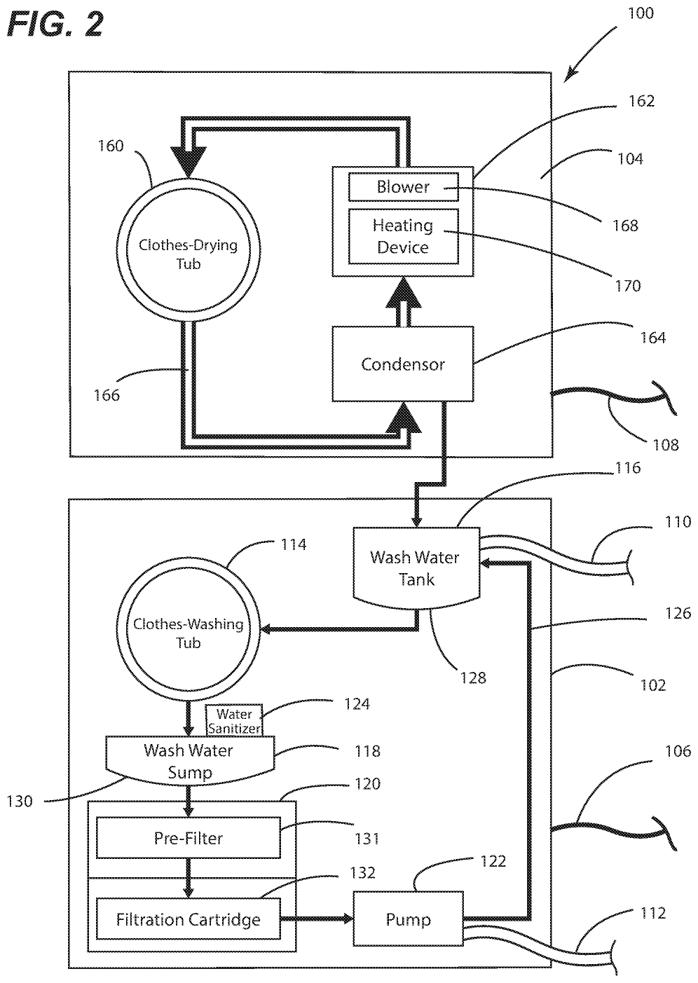

Referring to FIGS. 1 and 2, a laundry system 100 configured in accordance with an embodiment of the present invention is shown. More specifically, the laundry system 100 is preferably operable for a plurality of laundry cycles (i.e., wash and optionally dry cycles) with only a standard power supply outlet and initial wash water fill. The laundry system 100 preferably can re-use water from an onboard tank component via internal plumbing. To this end, the laundry system 100 preferably comprises an onboard wash water (i.e., grey water) treatment component to make system-assisted laundry more accessible to users with no designated facilities (e.g., plumbing, discharge vent or the like). To provide for such onboard wash water treatment component, the laundry system 100 can comprise one or more filter cartridges that treat the wash water to a state of reclamation sufficient for enabling reuse of the wash water in a plurality of wash cycles. Optionally, the one or more filter cartridges can be omitted or configured for wash water to not be reclaimed, whereby wash waster for each wash cycle is added prior to a given wash cycle instance and drained before the next wash cycle instance.

Moreover, the laundry system 100 preferably comprises a dryer that does not require a discharge vent and that harvests (i.e., reclaims) wash water from the dryer cycle. Rather than vent water vapor removed from the clothes during their drying to the atmosphere, that water vapor is condensed and is stored for use in one or more subsequent wash cycles. In one or more embodiments, the condensed water vapor can be subjected to the on-board wash water treatment component prior to being stored for use in the subsequent wash cycle(s).

As shown in FIGS. 1 and 2, the laundry system 100 comprises a washer unit 102 and a dryer unit 104. The washer unit 102 and the dryer unit 104 are each attachable to an electrical power supply through a respective electrical cable 106, 108. The electrical cable 106 of the washer unit 102 provides electrical power to electrical components of the washer unit 102 (e.g., wash water sanitizer(s), water pump(s), motor(s) and the like). The electrical cable 108 of the dryer unit 104 provides electrical power to electrical components of the dryer unit 104 (e.g., heating device(s) wash water sanitizer(s), water pump(s), motor(s) and the like). As discussed below in greater detail, the washer unit 102 preferably has a fluid in-fill structure 110 (e.g., a hose, fill port, or the like) for enabling selective supply of wash water thereto and a fluid discharge structure 112 (e.g., a hose, discharge port, drain or the like) for enabling selective discharge of wash water therefrom.

The washer unit 102 and dryer unit 104 are individually and/or jointly configured for the dryer unit 104 to be in a stacked position on top of the washer unit 102. In one or more embodiments, the washer unit 102 and dryer unit 104 can be contained in the same enclosure or housing. As discussed below in more detail, vertical placement of the dryer unit 104 relative washer unit 102 may require associated component requirements such as alternate/optional water pumps for ensuring/providing required water flow within and/or between the washer unit 102 and dryer unit 104.

As shown in FIG. 2, the washer unit 102 comprises a clothes-washing tub 114, a wash water tank 116, a wash water sump 118, a water filtration structure 120, a first water pump 122 and a water sanitizer 124. In one or more embodiments of the present invention, a wash water flow path 126 extends in a circuitous manner through the clothes-washing tub 114, the wash water tank 116, the wash water sump 118, the water filtration structure 120 and the first water pump 122. Specifically, a water outlet of the wash water tank 116 (i.e., a first wash water container) is in fluid communication with a water inlet of the clothes-washing tub 114. A water outlet of the clothes-washing tub 114 is in fluid communication with a water inlet of the wash water sump 118 (i.e., a second wash water container). A water inlet of the water filtration structure 120 is in fluid communication with a water outlet of the wash water sump 118 and a water outlet of the water filtration structure 120 is in fluid communication with a water inlet of the wash water tank 116 through the first water pump 122. One or more electrically actuated flow valves and a flow controller (not specifically shown) can be utilized for controlling the flow of wash water through the wash water flow path 126.

In preferred embodiments, the fluid in-fill structure 110 can be attached to the wash water tank 116 through a dedicated port, through the water inlet (e.g., through a flow selection valve), or the like for enabling supply of wash water into the wash water tank 116. In one or more embodiments, the fluid discharge structure 112 can be attached within the wash water flow path 126 (e.g., at the wash water sump, the water filtration structure 120, the first water pump 122 or piping/fluid conduit extending therebetween) through a dedicated port or water outlet thereof (e.g., through a flow selection valve), or the like for enabling used wash water to be discharged.

In preferred embodiments, at least a portion of an interior space of the wash water tank 116 is located at a position above the water inlet of the clothes-washing tub 114 for enabling wash water to be provided solely by gravity-fed flow from the wash water tank 116 to the clothes-washing tub 114. In some embodiments, one or more other water pumps (not shown) besides the first water pump 122 can be provided at a respective location for enhancing or enabling water flow within the wash water flow path 126. For example, a second wash water pump can be provided between the wash water tank and the clothes-washing tub 114, such as to enable water flow therebetween when the wash water tank is located at or below the clothes-washing tub 114. The first water pump 122 and any other water pumps of the laundry system 100 are each preferably an electrically drive pump that pressurized the flow of wash water. Alternatively, one or more water pumps of the laundry system 100 can be manually-driven.

In preferred embodiments, the wash water tank 116 has an interior space partially defined by a contoured lower wall 128. The contoured lower wall 128 can taper to a water collection region defined by a lowest location of the interior space of the wash water tank 118. The water outlet of the wash water tank 116 can extends through the contoured lower wall 128 within the water collection region thereof to promote gravity feed and full emptying of wash water from the wash water tank 114.

The wash water sump 118 preferably provides a capture and temporary storage space for wash water draining from the clothes-washing tub 114 prior to being subject to subsequent filtration at the water filtration structure 120 (or draining from the wash water flow path 126). The wash water sump 118 is preferably an enclosed tank where wash water flows into the wash water sump 118 through the eater inlet thereof and flows out of the wash water sump 118 through the wash water outlet thereof. In preferred embodiments, the wash water sump 118 has an interior space partially defined by a contoured lower wall 130. The contoured lower wall 130 can taper to a water collection region defined by a lowest location of the interior space of the wash water sump 118. The water outlet of the wash water sump 118 can extends through the contoured lower wall 130 within the water collection region thereof to promote gravity feed and full emptying of wash water from the wash water sump 118.

The wash water sanitizer 124 serves the purpose of killing microorganisms in the wash water such as, for example, by exposing wash water to light of a designated wavelength (e.g., ultraviolet (UV) light) for killing organisms residing in the wash water. In one or more embodiments, the wash water sanitizer 124 can be integral with the clothes-washing tub 114 and/or the wash water sump 118. In preferred embodiments, the wash water sanitizer 124 is mounted on the wash water sump 118 and a valve or other device can be provided for allowing wash water to be retained within the interior space of the wash water sump 118 prior to and during activation of the wash water sanitizer 124. One or more other additional wash water sanitizers can be implemented at a respective location(s) different than the wash water sanitizer 124.

As shown in FIG. 2, the water filtration structure 120 preferably comprises a pre-filter 131 and a filtration cartridge 132. The pre-filter 131 can be a filtration media (e.g., screen or the like) that filters gross contaminants (e.g., physical debris such as lint, small objects and the like). The filtration cartridge 132 is preferably a disposable unit that can treat the wash water to permit the wash water to be reused for a plurality of wash cycle instances. The filtration cartridge enclosure 120, the pre-filter 131, and the water filtration cartridge 132 are preferably jointly configured for causing an entire portion of wash water to flow through an interior space of the pre-filter 131 and filter cartridge 132 before entering the water outlet of the filtration cartridge enclosure 120.

The pre-filter 131 can be a removable (e.g., disposable or cleanable) cartridge or a body that jointly forms a filter enclosure with a mating portion of the water filtration structure 120. The filtration cartridge 132 is preferably a disposable item comprising a body within which media providing various filtration functionality is provided. To promote biodegradation of the filtration cartridge 132, a body of the filtration cartridge 132 can preferably be made from a porous polymeric material and the polymeric material can preferably be impregnated with at least one enzyme that accelerates biodegradation of the polymeric material. In one or more embodiments, the filtration cartridge 132 can provide the functionalities of gross and/or microscopic particle filtration, coagulation (i.e., use of a coagulant to aggregate particulates/contaminants to enable removal of undissolved solids), flocculation (i.e., separation of solid particles from a liquid to form loose aggregations, soft flakes or the like to enable removal of undissolved solids), and/or organic compound absorption.

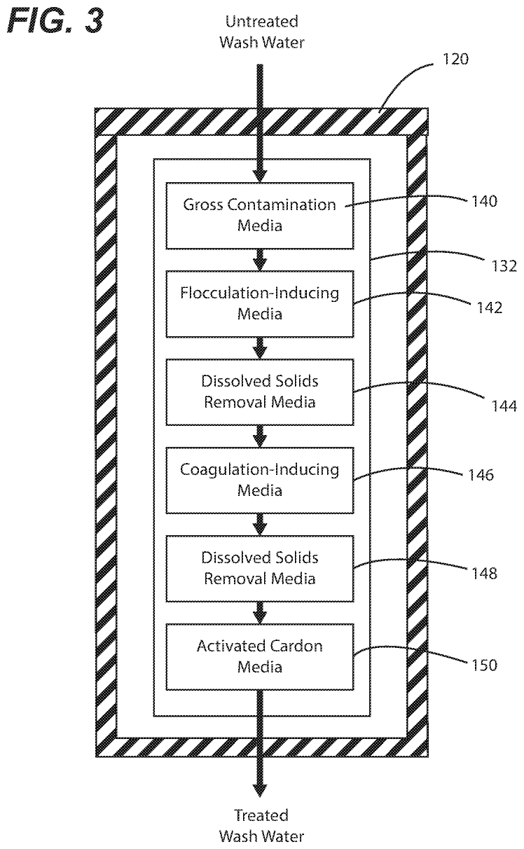

As shown in FIG. 3, in a preferred embodiment, the filtration cartridge 132 includes a plurality of filtration stages 140-150 arranged in an end-to-end manner. Untreated water enters a first one of the filtration stages (e.g., filtration stage 140) and treated water exits the last one of the filtration stages (e.g., filtration stage 150). Each of the filtration stages 140-150 can be provided within a respective one of a plurality of internal structural segments of the filtration cartridge 132. For example, the internal structural segments can be individual chambers within an interior space of a body of the filtration cartridge 132 whereby adjacent ones of the filtration stages and internal structural segments associated therewith are in fluid communication with each other such that wash water flows sequentially through each of the internal structural segments and thereby the respective one of the filtration stages 140-150 thereof.

In one preferred embodiment of filtration cartridge 132, one or more of the filtration stages includes a filter screen (e.g., for particulate filtration), one or more of the filtration stages includes at least one of a polyelectrolyte material composition and a salt-based material composition (e.g., for flocculation and/or coagulation filtration) and oneor more of the filtration stages includes at least one of a particulate filter foam and a particulate-capturing membrane (e.g., for solids filtration). In another preferred embodiment of filtration cartridge 132, a first one of the filtration stages (e.g., first filtration stage 140) includes a filter screen, a second one of the filtration stages (e.g., second filtration stage 142) includes a hard-water inducing (e.g., flocculation) salt-based material composition, a third one of the filtration stages (e.g., third filtration stage 144) includes a first microfiltration media, a fourth one of the filtration stages (e.g., fourth filtration stage 146) includes a coagulation-inducing salt-based material composition, a fifth one of the filtration stages (e.g., fifth filtration stage 148) includes a second microfiltration media and a sixth one of the filtration stages (e.g., sixth filtration stage 150) includes an organic compound absorption media (e.g., activated carbon).

Referring now back to FIG. 2, the dryer unit 104 preferably comprises a clothes-drying tub 160, an air handler 162 and a water vapor condenser 164. The clothes-drying tub 160 (e.g., an interior space thereof), the air handler 162 and the water vapor condenser 164 jointly define an airflow path 166. The airflow path 166 provides for airflow through the clothes-drying tub 160, the air handler 162 and the water vapor condenser 164 (i.e., an airflow structure) in a circuitous manner. In one or more embodiments, such circuitous airflow comprises airflow from the clothes-drying tub 160 to the air handler 162 through the water vapor condenser 164 and from the air handler 162 to the clothes-drying tub 160. In one or more other embodiments, the water vapor condenser 164 can be located between the airflow handler 162 and the clothes-washing tub 160.

The air handler 162 can comprise a blower 168 and a heating device 170. The blower 168 and the heating device 170 cane be separate system components (e.g., each having a separate and distinct enclosure jointly defining the air handler 162) or can be system components that are housed within a common enclosure of the air handler 162. The blower 168 is an airflow inducer that provides forced-airflow through the airflow path 166. The heating device 170 heats (i.e., increases thermal energy of) air within the airflow path 166 that is delivered to the clothes-drying tub 160. Such air heating causes water (e.g., wash water) within clothes in the clothes-drying tub 160 to evaporate and be carried within the air from the clothes-drying tub 160 to water vapor condenser 164 for being extracted from the air by the water vapor condenser 164 thereby producing condensed water vapor (i.e., water).

Advantageously, condensed water vapor from the water vapor condenser 164 can be provided from the dryer unit 104 to the washer unit 102 thereby allowing wash water used to wash clothes in the washer unit 102 (or other water in the clothes) to be reclaimed during drying of such clothes in the dryer unit 104. Preferably, a condensed water vapor outlet of the water vapor condenser 154 is in fluid communication with the washer unit 102 for allowing condensed water vapor from the water vapor condenser 164 to be provided to one or more components of the washer unit 102. For example, the condensed water vapor can flow from the water vapor condenser 164 to the wash water tank 116 to the clothes-washing tub 114, the wash water sump 118 and/or any other component defining the wash water flow path 126. To promote flow of condensed water vapor from the dryer unit 104 to the washer unit 102, a condensed water vapor outlet of the water vapor condenser 164 can preferably be located at a position above at least a portion of the washer unit 102 (e.g., above an interior space of the wash water tank 116) thereby enabling condensed water vapor from the dryer unit 104 to be provided solely by gravity-fed flow from the water vapor condenser 164 to the washer unit 102. In one or more embodiments, one or more water pumps can be provided in the washer unit 102 and/or the dryer unit 104 for inducing water flow from the dryer unit 104 to the washer unit 102.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

1. A clothes washer, comprising:
a first wash water container;
a clothes-washing tub having a water inlet thereof in fluid communication with a water outlet of the first wash water container;
a second wash water container having a water inlet thereof in fluid communication with a water outlet of the clothes-washing tub, wherein at least a portion of an interior space of the clothes-washing tub is located at a position above the water inlet of the second wash water container thereby enabling wash water to be provided solely by gravity-fed flow from the clothes-washing tub to the second wash water container;
a filtration cartridge enclosure having a water inlet thereof in fluid communication with a water outlet of the second wash water container through an interior space of the filtration cartridge enclosure and having a water outlet thereof in fluid communication with a water inlet of the first wash water container; and
ter filtration cartridge removably mounted within an interior space of the filtration cartridge enclosure.

2. The clothes washer of claim 1, further comprising:
a wash water sanitizer that emits ultraviolet light, wherein the wash water sanitizer and at least one of the clothes-washing tub and the second wash water container are jointly configured for exposing wash water within the second wash water container to said ultraviolet light.

3. The clothes washer of claim 1 wherein at least a portion of an interior space of the first wash water container is located at a position above the water inlet of the clothes-washing tub for enabling wash water to be provided solely by gravity-fed flow from the first wash water container to the clothes-washing tub.

4. The clothes washer of claim 1 wherein an entire portion of an interior space of the first wash water container is located at a position above the water inlet of the clothes-washing tub for enabling wash water to be provided solely by gravity-fed flow from the first wash water container to the clothes-washing tub.

5. The clothes washer of claim 1, further comprising:
a first water pump having a water inlet thereof in fluid communication with the water outlet of the filtration cartridge enclosure and having a water outlet thereof in fluid communication with the water inlet of the first wash water container.

6. The clothes washer claim 1 wherein:
the second wash water container has an interior space partially defined by a contoured lower wall thereof;
the contoured lower wall tapers to a water collection region defined by a lowest location of the interior space thereof; and
the water outlet of the second wash water container extends through the contoured lower wall within the water collection region thereof.

7. The clothes washer of claim 1 wherein:
the first wash water container has an interior space partially defined by a contoured lower wall thereof;
the contoured lower wall tapers to a water collection region defined by a lowest location of the interior space thereof;
the water outlet of the first wash water container extends through the contoured lower wall within the water collection region thereof; and
the water outlet of the first wash water container is located at a position above the water inlet of the clothes-washing tub for enabling wash water to be provided solely by gravity-fed flow from the first wash water container to the clothes-washing tub.

8. The clothes washer of claim 7 wherein at least a portion of an interior space of the first wash water container is located at a position above the water inlet of the clothes-washing tub for enabling wash water to be provided solely by gravity-fed flow from the first wash water container to the clothes-washing tub.

9. The clothes washer of claim 8 wherein:
the second wash water container has an interior space partially defined by a contoured lower wall thereof;
the contoured lower wall tapers to a water collection region defined by a lowest location of the interior space thereof; and
the water outlet of the second wash water container extends through the contoured lower wall within the water collection region thereof

10. The clothes washer of claim 1 wherein the filtration cartridge enclosure and a body of the water filtration cartridge are jointly configured for causing an entire portion of wash water provided into an interior space of the filtration cartridge enclosure to pass through an interior space of the body of the water filtration cartridge before entering the water outlet of the filtration cartridge enclosure

11. The clothes washer of claim 10 wherein:
the filtration cartridge includes a plurality of filtration stages;
the filter cartridge includes a cartridge body having a plurality of structural segments;
each of said filtration stages is provided within a respective one of structural segments;
said structural segments are arranged in an end-to-end manner; and
adjacent ones of said structural segments are in fluid communication with each other such that wash water flows sequentially through each of said structural segments.

12. The clothes washer of claim 11 wherein:
a first one of the filtration stages includes a filter screen, a second one of the filtration stages includes at least one of a polyelectrolyte material composition and a salt-based material composition; and
a third one of the filtration stages includes at least one of a particulate filter foam and a particulate-capturing membrane.

13. The clothes washer of claim 11 wherein:
a first one of the filtration stages includes a filter screen;
a second one of the filtration stages includes a hard-water inducing salt-based material composition;
a third one of the filtration stages includes a first microfiltration media;
a fourth one of the filtration stages includes a coagulation-inducing salt-based material composition;
a fifth one of the filtration stages includes a second microfiltration media; and
sixth one of the filtration stages includes activated carbon.

14. The clothes washer of claim 11 wherein:
the cartridge body is made from a porous polymeric material; and
the polymeric material is impregnated with at least one enzyme.

15. A laundry system, comprising:
a wash water tank;
a clothes-washing tub in fluid communication with the wash water tank to enable wash water to be provided from the wash water tank to the clothes-washing tub, wherein at least a portion of an interior space of the wash water tank is located at a position above a water inlet of the clothes-washing tub for enabling wash water to be provided solely by gravity-fed flow from the wash water tank to the clothes-washing tub;
a wash water sump in fluid communication with the clothes-washing tub to enable wash water to be provided from the clothes-washing tub to the wash water sump, wherein at least a portion of an interior space of the clothes-washing tub is located at a position above a water inlet of the wash water sump thereby enabling wash water to be provided solely by gravity-fed flow from the clothes-washing tub to the wash water sump;
a water filtration structure comprising a filtration cartridge enclosure and a water filtration cartridge, wherein the filtration cartridge enclosure has a water inlet thereof in fluid communication with a water outlet of the wash water sump through an interior space of the filtration cartridge enclosure and has a water outlet thereof in fluid communication with a water inlet of the wash water tank, wherein the water filtration cartridge is removably mounted within an interior space of the filtration cartridge enclosure and wherein the filtration cartridge enclosure and a body of the water filtration cartridge are jointly configured for causing an entire portion of wash water provided into an interior space of the filtration cartridge enclosure to pass through an interior space of the body of the water filtration cartridge before entering the water outlet of the filtration cartridge enclosure;
a water vapor condenser in fluid communication with the wash water tank to enable condensed water vapor to be provided from the water vapor condenser to the wash water tank; and
an airflow structure comprising a clothes-drying tub, an air handler and the water vapor condenser, wherein the clothes-drying tub, the air handler and the water vapor condenser jointly define an airflow pathway for enabling airflow therethrough in a circuitous manner from the clothes-drying tub to the air handler through the water vapor condenser and from the air handler to the clothes-drying tub.

16. The laundry system of claim 15, further comprising:
a wash water sanitizer that emits ultraviolet light, wherein the wash water sanitizer and at least one of the clothes-washing tub and the wash water sump are jointly configured for exposing wash water to said ultraviolet light.

17. The laundry system of claim 15 wherein at least a portion of an interior space of the wash water tank is located at a position above the water inlet of the clothes-washing tub for enabling wash water to be provided solely by gravity-fed flow from the wash water tank to the clothes-washing tub.

18. The laundry system of claim 17 wherein a condensed water vapor outlet of the water vapor condenser is located at a position above at least a portion of the interior space of the wash water tank thereby enabling condensed water vapor to be provided solely by gravity-fed flow from the water vapor condenser to the interior space of the wash water tank.

19. The laundry system of claim 18, further comprising:
a first water pump having a water inlet thereof in fluid communication with the water outlet of the filtration cartridge enclosure and having a water outlet thereof in fluid communication with the water inlet of the first wash water tank.

20. The laundry system of claim 15 wherein:
the wash water tank has an interior space partially defined by a contoured lower wall thereof;
the contoured lower wall tapers to a water collection region defined by a lowest location of the interior space thereof;
the water outlet of the wash water tank extends through the contoured lower wall within the water collection region thereof; and
the water outlet of the wash water tank is located at a position above the water inlet of the clothes-washing tub for enabling wash water to be provided solely by gravity-fed flow from the wash water tank to the clothes-washing tub.

21. The laundry system of claim 20 wherein at least a portion of an interior space of the wash water tank is located at a position above the water inlet of the clothes-washing tub for enabling wash water to be provided solely by gravity-fed flow from the wash water tank to the clothes-washing tub.

22. The laundry system of claim 21 wherein:
the wash water sump has an interior space partially defined by a contoured lower wall thereof;
the contoured lower wall tapers to a water collection region defined by a lowest location of the interior space thereof; and
the water outlet of the wash water sump extends through the contoured lower wall within the water collection region thereof

23. The laundry system of claim 15 wherein:
the filtration cartridge includes a plurality of filtration stages;
the filter cartridge includes a cartridge body having a plurality of structural segments;
each of said filtration stages is provided within a respective one of structural segments;
said structural segments are arranged in an end-to-end manner; and
adjacent ones of said structural segments are in fluid communication with each other such that wash water flows sequentially through each of said structural segments.

24. A laundry system, comprising:
a washer unit comprising a clothes-washing tub, a wash water tank, a wash water sump, a water filtration structure, a first water pump and a wash water sanitizer, wherein a water outlet of the wash water tank is in fluid communication with a water inlet of the clothes-washing tub, wherein a water outlet of the clothes-washing tub is in fluid communication with a water inlet of the wash water sump, wherein a water inlet of the water filtration structure is in fluid communication with a water outlet of the wash water sump and a water outlet of the water filtration structure is in fluid communication with a water inlet of the wash water tank through the first water pump, wherein at least a portion of an interior space of the wash water tank is located at a position above the water inlet of the clothes-washing tub for enabling wash water to be provided solely by gravity-fed flow from the wash water tank to the clothes-washing tub, wherein the wash water sanitizer emits ultraviolet light and wherein the wash water sanitizer and at least one of the clothes-washing tub and the wash water sump are jointly configured for exposing wash water to said ultraviolet light; and
a dryer unit comprising a clothes-drying tub, an air handler and a water vapor condenser, wherein the clothes-drying tub, the air handler and the water vapor condenser jointly define an airflow pathway for enabling airflow therethrough in a circuitous manner from the clothes-drying tub to the air handler through the water vapor condenser and from the air handler to the clothes-drying tub, wherein a condensed water vapor outlet of the water vapor condenser is located at a position above at least a portion of the interior space of the wash water tank thereby enabling condensed water vapor to be provided solely by gravity-fed flow from the water vapor condenser to the interior space of the wash water tank.

25. The laundry system of claim 24 wherein the water outlet of the wash water tank is located at a position above the water inlet of the clothes-washing tub and the water outlet of the clothes-washing tub is located at a position above the water inlet of the wash water sump thereby enabling wash water to be provided solely by gravity-fed flow from the wash water tank to the wash water sump through the clothes-washing tub.

26. The laundry system of claim 24 wherein a condensed water vapor outlet of the water vapor condenser is in fluid communication with the wash water tank, wherein the condensed water vapor outlet of the water vapor condenser is located at a position above at least a portion of an interior space of the wash water tank thereby enabling condensed water vapor to be provided solely by gravity-fed flow from the water vapor condenser to the interior space of the wash water tank.

27. The laundry system of claim 24 wherein:
the wash water tank has an interior space partially defined by a contoured lower wall thereof;
the contoured lower wall tapers to a water collection region defined by a lowest location of the interior space thereof;
the water outlet of the wash water tank extends through the contoured lower wall within the water collection region thereof; and
the water outlet of the wash water tank is located at a position above the water inlet of the clothes-washing tub for enabling wash water to be provided solely by gravity-fed flow from the wash water tank to the clothes-washing tub.

28. The laundry system of claim 27 wherein at least a portion of an interior space of the wash water tank is located at a position above the water inlet of the clothes-washing tub for enabling wash water to be provided solely by gravity-fed flow from the wash water tank to the clothes-washing tub.

29. The laundry system of claim 28 wherein:
the wash water sump has an interior space partially defined by a contoured lower wall thereof;
the contoured lower wall tapers to a water collection region defined by a lowest location of the interior space thereof; and
the water outlet of the wash water sump extends through the contoured lower wall within the water collection region thereof.
